(19) United States
(12) Patent Application Publication
(10) Pub. No.: US 2013/0180290 A1
(43) Pub. Date: Jul. 18, 2013

(54) CONTROLLING GLASSMELTING FURNACE GAS CIRCULATION

(71) Applicants: Hisashi Kobayashi, Millertown, NY (US); William Thoru Kobayashi, Williamsville, NY (US); Junlu Yuan, Shanghai (CN)

(72) Inventors: Hisashi Kobayashi, Millertown, NY (US); William Thoru Kobayashi, Williamsville, NY (US); Junlu Yuan, Shanghai (CN)

(21) Appl. No.: 13/719,380

(22) Filed: Dec. 19, 2012

Related U.S. Application Data
(60) Provisional application No. 61/578,425, filed on Dec. 21, 2011.

(51) Int. Cl. C03B 5/225

(52) U.S. Cl. CPC C03B 5/225
USPC 65/134.4; 65/134.6

(57) ABSTRACT

Injecting one or opposed gaseous streams into the atmosphere over molten glassmaking materials in a glassmelting furnace, in a region of the refining zone, improves the quality of the glassmelt and lessens the risk of crown corrosion.

### FIELD OF THE INVENTION

The present invention relates to operation of glassmelting furnaces, in which glassmaking ingredients are melted to produce a bath of molten glassmaking material from which solid glass can be produced.

### BACKGROUND OF THE INVENTION

In the manufacture of glass, glassmaking materials are melted in a glassmelting furnace by heat provided from burners which combust fuel with oxygen. The fuel can be combusted with air as the source of the oxygen, or with a stream containing a higher oxygen content than that of air. The furnace must be manufactured of material that can withstand the very high temperatures that prevail within the furnace. The materials of construction often employed, which typically include AZS and silica refractory and related materials, are well known.

However, the conditions within the glassmelting furnace have been known to cause corrosion of the inner surfaces of the furnace, especially of the roof (“crown”) over the glassmaking materials. The most widely used material for the crown is silica brick for soda-lime-silicate glass furnaces. Alkali vapors (mostly NaOH and KOH) generated from the glass batch material and molten glass in the glassmelting furnace react with silica refractory brick and form over time a glassy silicate material on the inner surface of the crown. When a sufficient concentration of alkali oxides (mainly Na₂O and K₂O) accumulates in the glassy silicate layer, the glassy material can become fluid enough to drip directly into the molten glass in the furnace or to run along the silica refractory surface and over other refractory surfaces in the furnace and dissolve or dislodge some of the refractory particles which fall into the molten glass. This corrosion is undesirable as it leads to a loss of material in the crown, which eventually leads to expensive repairs or replacement of the crown, and because the corrosion products have been known to fall into the pool of molten glass materials in the furnace and to cause defects in the glass product.

The present invention provides methodology for controlling the furnace atmosphere to reduce corrosion of refractory materials and to improve the quality of glass, in particular, to increase the oxidation state of glass, i.e., to reduce the redox ratio, which is the molar ratio of ferrous iron to ferric iron, to produce glass characterized by high transmission of light for uses such as clear flat glass and glass tablewares. Preferably the redox ratio is reduced by 0.01 to 0.20.

### BRIEF SUMMARY OF THE INVENTION

One aspect of the invention is a method of operating a glassmelting furnace, the furnace including a glassmelting chamber defined by opposed side walls, a back wall, a roof, and a front wall, the method comprising:

(A) melting glassmaking material in a melting zone of said glassmelting chamber to establish a bath of molten glassmaking material, by heat provided to the melting zone over said bath by combustion of fuel and preheated oxidant from two or more pairs of opposed regenerator ports in said side walls of said glassmelting furnace, wherein said combustion forms an atmosphere comprising combustion products over said bath in said melting zone,

(B) passing molten glassmaking material from the melting zone into and through a refining zone of the glassmelting chamber, and then out of said glassmelting chamber through a port in said front wall, without combustion of fuel and oxidant in said refining zone over said molten glassmaking materials, and

(C) injecting at least one gaseous stream into the refining zone above the molten glassmaking material, from at least one location in at least one side wall of said refining zone, in a direction toward the other side wall of said refining zone, or from at least one location in said front wall in a direction toward said back wall, with sufficient momentum to reduce the flow of said combustion products from said melting zone into said refining zone.

Another aspect of the invention is a method of operating a glassmelting furnace, the furnace including a glassmelting chamber defined by opposed side walls, a back wall, a roof, and a front wall, the method comprising:

(A) melting glassmaking material in a melting zone of said glassmelting chamber to establish a bath of molten glassmaking material, by heat provided to the melting zone over said bath by combustion of fuel and preheated oxidant from two or more pairs of opposed regenerator ports in said side walls of said glassmelting furnace, wherein said combustion forms an atmosphere comprising combustion products over said bath in said melting zone,

(B) passing molten glassmaking material from the melting zone into and through a refining zone of the glassmelting chamber, and then out of said glassmelting chamber through a port in said front wall, without combustion of fuel and oxidant in said refining zone over said molten glassmaking materials,

(C) injecting at least one gaseous stream or atomized fluid stream comprising 21 vol. % to 100 vol. % oxygen into the refining zone above the molten glassmaking material to increase the average oxygen concentration in the atmosphere near said bath surface in said refining zone by 1 to 60 vol. %, and

(D) adjusting the fuel and combustion air flow rates of each of said regenerator ports to make the oxygen concentration in the flue gas exiting each of said regenerator ports between 1 to 6 vol. %,

As used herein, “glassmaking materials” comprise any of the following materials, and mixtures thereof: sand (mostly SiO₂), soda ash (mostly Na₂CO₃), limestone (mostly CaCO₃ and MgCO₃), feldspar, borax (hydrated sodium borate), other oxides, hydroxides and/or silicates of sodium and potassium, and glass (such as recycled solid pieces of glass) previously produced by melting and solidifying any of the foregoing. Glassmaking materials may also include functional additives such as batch oxidizers such as salt cake (sodium sulfate, Na₂SO₄) and/or niter (sodium nitrate, NaNO_{3,} and/or potassium nitrate, KNO₃), and fining agents such as antimony oxides (Sb₂O₃).

As used herein, “alkali species” means chemical compounds containing sodium, potassium and/or lithium atoms, including but not limited to sodium hydroxide, potassium hydroxide, products formed by decomposition of sodium hydroxide or potassium hydroxide at temperatures greater than 1200° C., and mixtures thereof.

As used herein, “oxy-fuel burner” means a burner through which are fed fuel and oxidant having an oxygen content greater than the oxygen content of air, and preferably having an oxygen content of at least 50 volume percent and more preferably more than 90 volume percent.

As used herein, “oxy-fuel combustion” means combustion of fuel with oxidant having an oxygen content greater than the oxygen content of air, and preferably having an oxygen content of at least 50 volume percent and more preferably more than 90 volume percent.

As used herein, “atmosphere near said bath surface” means the gaseous layer extending from the bath surface to one foot above the bath surface.

### BRIEF DESCRIPTION OF THE DRAWINGS

FIG. 1 is a top plan view of a glassmelting furnace in which the present invention can be practiced.

FIG. 2 is a graphical representation of gas flows in the furnace of FIG. 1 when operated without the present invention.

FIG. 3 is a graphical representation of gas flows in the furnace of FIG. 1 when operated with one embodiment of the present invention.

FIG. 4 is a graphical representation of the oxygen concentration profile of the furnace atmosphere (in vol. % wet) near the glassmelt surface in the furnace of FIG. 1 when operated without the present invention in the manner represented by FIG. 2.

FIG. 5 is a graphical representation of the oxygen concentration profile of the furnace atmosphere (in vol. % wet) near the glassmelt surface in the furnace of FIG. 1 when operated with the embodiment of the present invention represented by FIG. 3.

FIG. 6 is a top plan view of a glassmelting furnace depicting alternative arrangements of the injection of gas into the furnace of FIG. 1 in accordance with another embodiment of the present invention.

### DETAILED DESCRIPTION OF THE INVENTION

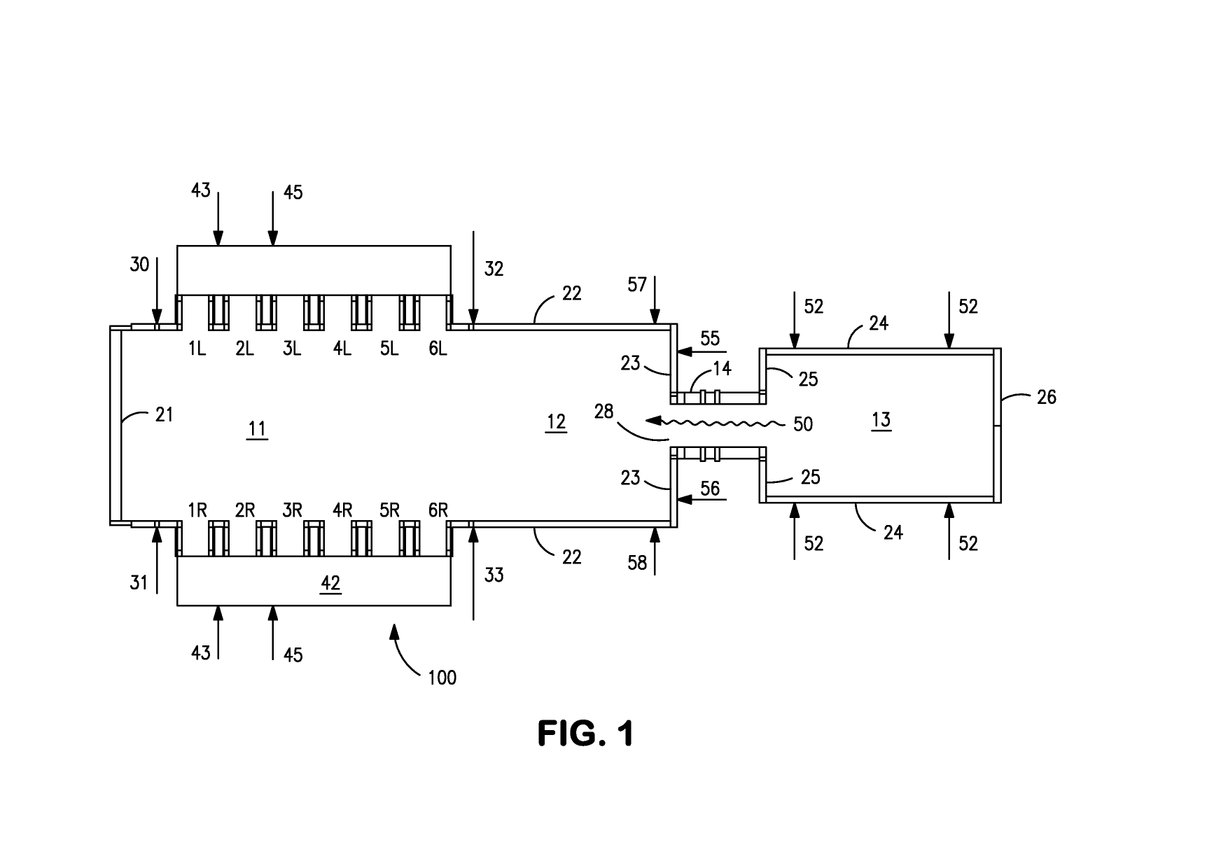

Turning first to the glassmaking furnace itself, FIG. 1 shows a top plan view of a typical cross fired float glass furnace 100 with regenerators, with which the present invention can be practiced. The present invention is not limited to float glass furnaces and can be practiced in other types of glass melting furnaces manufacturing, for example, tableware glasses, sheet glasses, display glasses, and container glasses. The furnace 100 includes melting zone 11 and refining zone 12. Melting zone 11 and refining zone 12 are enclosed within back wall 21, front wall 23, and side walls 22. A crown or roof (not depicted) connects to side walls 22, back wall 21, and front wall 23. The furnace 100 also has a bottom which together with back wall 21, side walls 22 and front wall 23 and the crown or roof, form the enclosure that holds the molten glassmaking materials.

Conditioning zone 13 is enclosed by side walls 24, front wall 25, end wall 26, and a crown or roof (not depicted) that connects to side walls 24, front wall 25, and end wall 26, as well as a bottom and a crown or roof. Conditioning zone 13 (when present) is located with respect to refining zone 12 to receive flowing molten glassmaking material from refining zone 12 for further conditioning of the molten material in the manner already familiar in this field. Waist zone 14 is a narrow passage connecting refining zone 12 and conditioning zone 13.

The particular shape of the bottom is not critical, although in general practice it is preferred that at least a portion of the bottom is planar and is either horizontal or sloped in the direction of the flow of the molten glass through the furnace. All or a portion of the bottom can instead be curved. The particular shape of the furnace as defined by its walls is also not critical, so long as the walls are high enough to hold the desired amount of molten glass and to provide (under the crown) space above the molten glass in which the combustion can occur that melts the glassmaking materials and keeps them molten.

The furnace 100 also has at least one material charging entrance (not shown), typically along the inner surface of back wall 21 or in side walls 22 near back wall 21 for other types of glass furnaces, through which glassmaking material can be fed into the melting zone 11. There can also be one or more flues through which products of the combustion of fuel and oxygen (within melting zone 11) can flow out of the interior of the furnace. The flue or flues are typically located in back wall 21, or in one or more side walls.

The bottom, sides and crown of the furnace should be made from refractory material that can retain its solid structural integrity at the temperatures to which it will be exposed, i.e. typically 1300° C. to 1700° C. Such materials are widely known in the field of construction of high-temperature apparatus. Examples include silica, fused alumina, and AZS.

The inner surface of the crown, i.e. the surface that is in contact with the furnace atmosphere, may be comprised of the original material of construction of the crown, and in some places may instead comprise a layer of slag that has formed on what was the uncorroded surface of the crown. Such a slag layer is typically formed due to reactions of volatile vapors and dust from glassmaking materials and molten glass and may often be found in furnaces that have already been in use. Typically, the slag layer contains silica, alkali oxide, alkaline earth oxide, and compounds thereof, such as contain calcium oxide and/or compounds of calcium oxide with silica and/or alkali oxide. Thus, the present invention can be carried out in furnaces in which the inner surface of the crown comprises corrosion product formed by reaction of the surface with alkali hydroxide, and in furnaces in which the inner surface of the crown does not comprise corrosion product formed by reaction of the surface with alkali hydroxide.

Melting zone 11 includes two or more pairs of opposed regenerator ports in side walls 22. By “opposed” is meant that in a given pair of regenerator ports, there is one port in each side wall 22, facing each other and both facing the interior of melting zone 11. The opposed ports are preferably essentially coaxial, that is they face directly across from each other; ports that are offset, wherein each port's axis is not coaxial with the other's, can be used but are not preferred. Combustion occurs in melting zone 11 as natural gas or fuel oil, injected at or near the locations where these ports open into melting zone 11, mixes with hot combustion air from regenerators 41 and 42, to form a flame and to generate heat in the melting zone to melt glassmaking material and maintain the glassmaking material in the molten state. The regenerator ports communicate with regenerators 41 and 42 as described further below. FIG. 1 shows six pairs of ports, with each pair of ports facing each other, the ports on one side of the melting zone being numbered from 1L to 6L and the ports on the other side of the melting zone being numbered 1R through 6R. Any number of ports can be employed, from 2 to 10 or even up to 20 or more, depending on the desired glassmelting capacity of the furnace. At or near the exit of each port one or more fuel injectors (not shown) are placed to inject fuel to form a flame (not shown) and generate heat in melting zone 11. Melting zone 11 is defined as the zone between back wall 21 and either the last pair of regenerator ports closest to the front wall 23, or the fuel injectors for the last pair of regenerator ports that are closest to front wall 23 if the fuel injectors are located closer to the front wall 23 than the port itself.

Optionally one or more flue gas ports (not depicted) not connected to regenerators 41 and 42 may be placed in one or more walls in melting zone 11 or in refining zone 12 to exhaust a portion of flue gas for additional heat recovery and other purposes.

Arrows 30 and 31 between back wall 21 and the ports 1L and 1R represent optional oxy-fuel burners often used to increase production and/or glass quality in the glass furnace.

Refining zone 12 is characterized in that it does not have apparatus for combusting additional fuel and oxidant over the molten glassmaking materials. Instead, the molten glassmaking material in refining zone 12 experiences complex recirculating flow patterns within the furnace and has a net flow gradually in a direction from the melting zone 11 through refining zone 12 toward and through port 28 in front wall 23, preferably into a conditioning zone 13. While the molten glass is in melting zone 11 and refining zone 12, dissolved gases are able to rise to the bath surface and leave the bath, and less volatile materials can become more uniformly distributed within the bath.

In operation, glassmaking material is fed into melting zone 11. Combustion in melting zone 11 provides heat that melts glassmaking material in the melting zone, and maintains the resulting bath of molten glassmaking material in the molten state. This combustion is carried out by combusting fuel, preferably natural gas or oil, with oxygen that is typically provided as air, or optionally as oxygen-enriched air or a stream comprising 50 vol. % up to 99 vol. % oxygen. The amount of fuel and oxygen fed and combusted must be sufficient to provide enough heat to melt the glassmaking materials that are fed to melting zone 11.

When combustion is carried out in melting zone 11 using regenerators, fuel (not shown in FIG. 1) is typically injected from below or from a side of each port at or near the port exit to the furnace toward the opposing port. Combustion air is preheated in the regenerator in the same side of the melting zone 11 (such as regenerator 41) and flows into melting zone 11, mixes with the injected fuel and forms a flame while gaseous products of the combustion, which are very hot, are withdrawn from melting zone 11 through the ports in the other side wall 22 of melting zone 11 and through the other regenerator (in this illustration, regenerator 42). The gaseous oxidant (i.e. air, oxygen-enriched air, or higher purity oxygen) represented by stream 43 passes through the regenerator and is heated by transfer of heat previously absorbed from hot gaseous products of combustion that were withdrawn through that regenerator in a previous cycle, before the oxidant is combusted with fuel in melting zone 11. While combustion is occurring in melting zone 11 with fuel and oxidant that are fed at or through the ports which communicate with regenerator 41, the hot gaseous products withdrawn through the ports that communicate with regenerator 42 heat the other regenerator 42. The regenerators are typically made of refractory brick or other material that can absorb heat at the high temperatures that are present (optionally, the regenerator may also contain additional objects such as balls or blocks of refractory material to absorb heat from the hot combustion gases.

After a period of time which is typically every 10 to 30 minutes, operation is reversed so that gaseous oxidant for combustion (e.g. air) from the other regenerator (i.e. regenerator 42) flows into melting zone 11 and combustion occurs with fuel injected from the same side as regenerator 42, and the resulting hot gaseous combustion products are withdrawn through the ports that are connected to regenerator 41. The oxidant that participates at this point in the combustion in melting zone 11 passes through regenerator 42 and is heated by heat transfer from heat stored regenerator 42 in the previous cycle. After another period of time, the direction of combustion air flow and fuel injection is reversed again. The regenerators represented by FIGS. 41 and 42 may be one common chamber on each side of melting zone 41, or may be a number of separate and distinct chambers each communicating with but one port connected to melting zone 11 of the furnace.

In some types of glassmelting furnaces, a stream 50 of gas (typically, air) flows into refining zone 12 through port 28 in front wall 23, in a direction toward melting zone 11. This stream 50 is typically a portion of air that cools the bath of molten glass in conditioning zone 13. In conventional practice not employing the present invention, stream 50 flows through refining zone 12 into melting zone 11. Conditioning zone 13 while preferred is not necessary in the present invention. When a conditioning zone 13 is employed, stream 52 of cooling gas is fed or injected into conditioning zone 13, for instance through four openings in wall 24 as shown by four arrows, and then a portion of cooling gas 52 flows through conditioning zone 13 into refining zone 12 through port 28 in waist zone 14 as gas stream 50. The remainder of cooling gas 52 is exhausted through exhaust ports (not shown) located in conditioning zone 13 or in waist zone 14.

In other types of glassmelting furnaces, no gas flows into refining zone 12 through port 28, as port 28 is submerged below the molten glass so that only molten glass flows through port 28. In these types of furnaces, some air may enter the refining zone through other openings.

Arrows 32 and 33 in refining zone 12 indicate locations at which at least one gaseous stream is injected in accordance with the present invention. These locations are in refining zone 12. A preferred location is in one or both side walls, between the front wall 23 and the regenerator port that is closest to the front wall 23 (or between the front wall 23 and the fuel injection port that is closest to the front wall 23, if such fuel injection port is closer to front wall 23 than the associated regenerator port is). A more preferred location is near that regenerator port or fuel injection port. While continuous gas injection from both injectors of an opposing pair of injectors 32 and 33 constitutes a preferred embodiment of this invention, the present invention can also be practiced with cyclic injection from only one injector at a time, preferably the injector that is on the side wall opposite to the side wall in which is located the regenerator that is firing at any given time. That is, gas would be injected from injector 32 when regenerator 42 is in the firing cycle, followed cyclically by injection from injector 33 when regenerator 41 is in the firing cycle. Each injector 32 or 33 can be an oxy-fuel burner to which fuel (such as natural gas) and oxygen are fed which combust in refining zone 12 to form a flame within the furnace. Each injector may comprise a single injector, or may comprise multiple injection nozzles or ports placed on side walls 22 from which different gases or atomized oil can be injected. A preferred injector has two injection ports mounted one over the other vertically (as depicted and described in U.S. Pat. No. 5,924,848). Alternatively, each injector 32 and 33 can inject (uncombusted) oxygen alone, air alone, oxygen-enriched air, or a gas mixture of any suitable composition. When gas is injected from more than one injector, such as injectors 32 and 33, the gases that are injected from any injector can have a composition different from or the same as the gases injected from any other injector. Optionally one or more streams of purge gas 55 through 58 is flowed into refining zone 12 through openings placed in front wall 23 and/or side walls 22. This purge gas stream, which is preferably oxygen, oxygen enriched air, or air when oxidized glass is produced, increases the oxygen concentration of the atmosphere in refining zone 12.

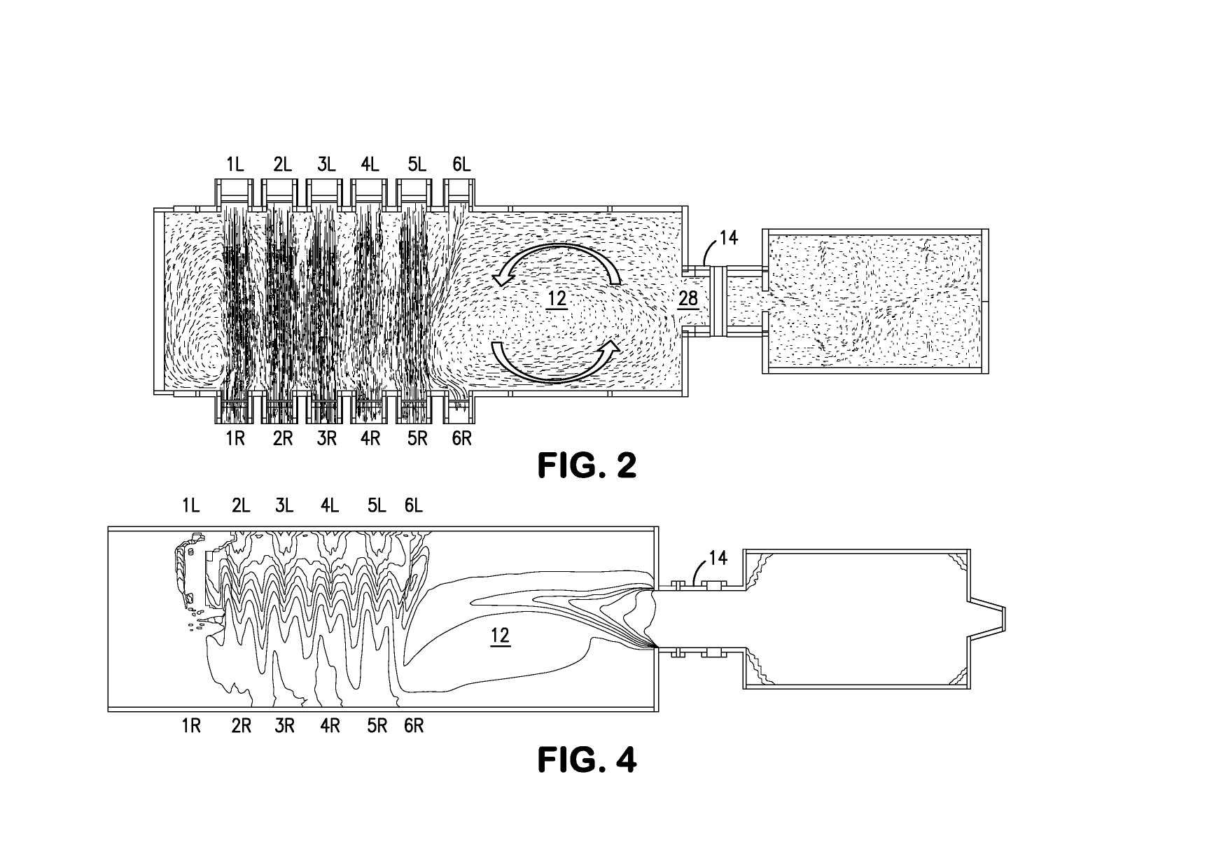

In a cross-fired regenerative glassmelting furnace such as depicted in FIG. 1, the furnace gas circulation pattern in melting zone 11 is driven principally by the momentum of combustion oxidant (air) and fuel injected into the melting zone 11. When the present invention is not being implemented, the combustion of oxidant and fuel in the melting zone (and the influence of the gaseous stream 50 or other gas stream that, if present, flows into the refining zone 12), have the effect of establishing a large recirculation gas flow pattern between the last pair of regenerator ports, i.e., ports 6L and 6R in FIG. 1, and the front wall 23, circulating in a region of the melting zone and out of the melting zone 11 into refining zone 12 and back into melting zone 11. When regenerator 41 is in the firing cycle the direction of the recirculation flow (shown as circle 61 in FIG. 2) in the refining zone 12 is in the counter-clockwise direction, and the pattern is reversed and the direction of the recirculation flow becomes clockwise when the other regenerator is instead in the firing cycle. When no other gases are injected in the refining zone 12 the composition of the gas in this recirculation gas flow pattern becomes very close to that of the gaseous combustion products (i.e. that are withdrawn through regenerator ports as described above) which typically contains 1-3% O₂ by volume. When cooling gas 50 flows into the refining zone as described herein, the composition of the atmosphere in the refining zone 12 is determined by the mixing pattern of the cooling air flowing into the refining zone 12 and the furnace gas circulating into the refining zone.

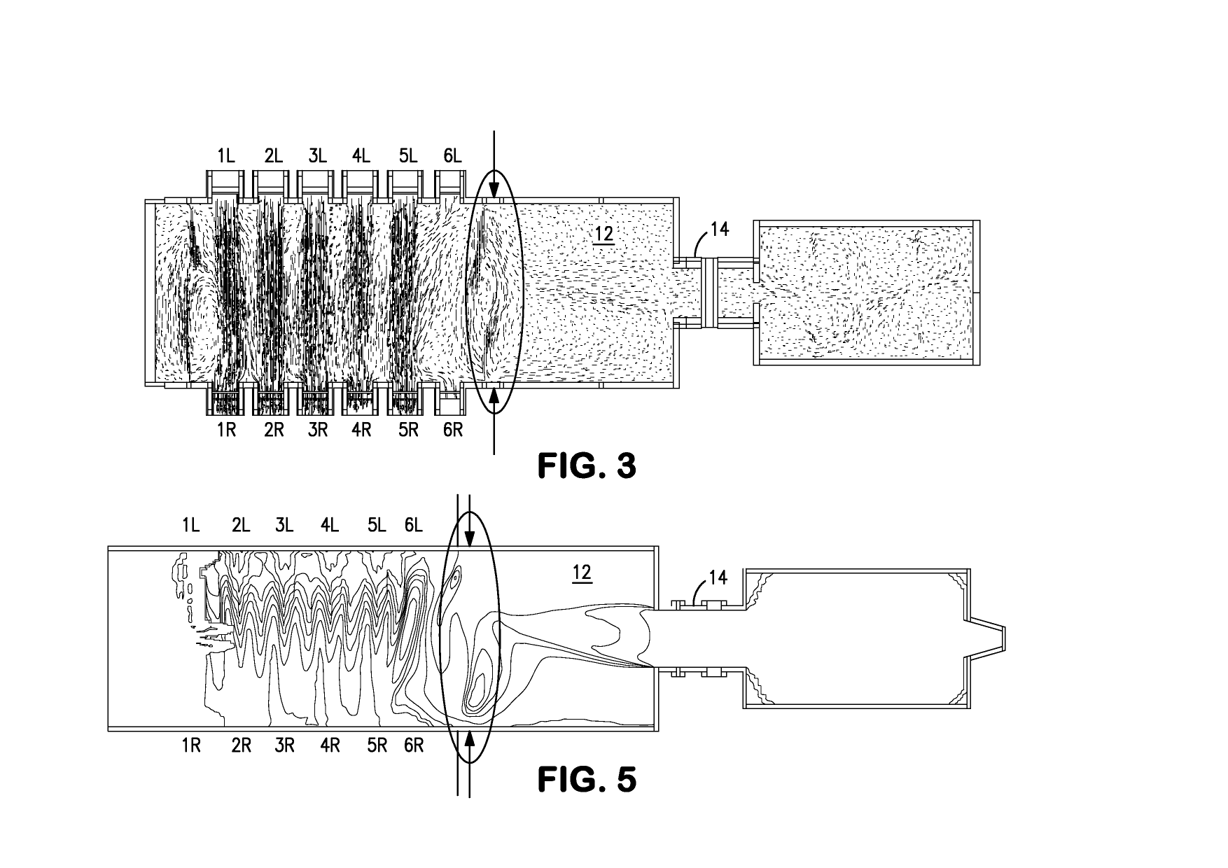

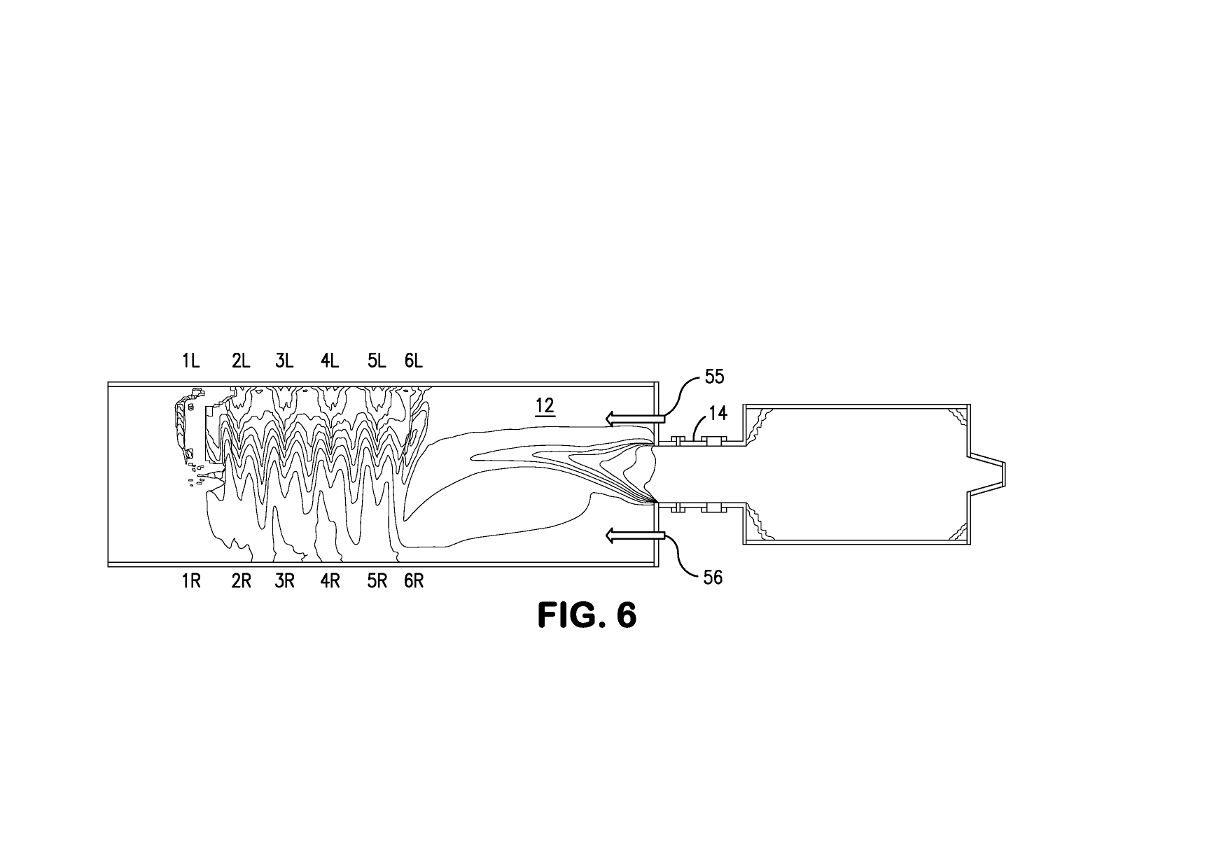

FIG. 3 depicts the gas flow pattern when the present invention is implemented with an opposing pair of oxy-oil burners placed on side walls 22. Atomized fuel oil and oxygen are injected as two opposing jets at the same time. Instead of the flow of gases circulating throughout refining zone 12, as depicted as 61 in FIG. 2, there is very little flow of gases from melting zone 11 circulating into refining zone 12. The flow of gases from the melting zone into the refining zone can be reduced by at least 10%, preferably by at least 20 or 25%, and more preferably by at least 40 or 50%. The amount of reduction can be determined by comparing the oxygen content of the atmosphere in the refining zone before and after implementation of the present invention. Implementation of the present invention increases the oxygen content of the refining zone atmosphere, proportionally to the degree to which the melting zone atmosphere has not been able to flow into the refining zone and cause dilution (relative to the oxygen content) of the refining zone atmosphere.

Application of computational fluid dynamic analysis to a typical 600 metric tpd float glass furnace (12.2 m wide×38.2 in long in the main furnace) of the type depicted in FIG. 1 when operated without the present invention predicted the oxygen concentration profile of the furnace atmosphere (in vol. % wet) near the glassmelt surface as shown in FIG. 4. The local O₂ concentration in the refining zone 12 was reduced to as low as 4% in a corner formed by side wall 22 and front wall 23 when 1,719 Nm³/hr of stream 50 (air) was flowing into the refining zone 12, which had about 21% O₂ at the port 28 in wall 23. Optional purge gas streams 55-58 were not injected in this example. The low local O₂ concentration in the refining zone 12 was caused by mixing with the circulating furnace gas which contained about 2% O₂. Except for the small areas near the port 28 in wall 23, the oxygen concentration in most of refining zone 12 was less than 10%. The average oxygen concentration in the refining zone was estimated to be about 5%. The furnace gas circulation pattern in refining zone 12 was driven primarily by the momentum of combustion oxidant (air) and fuel injected into the melting zone 11 from port 6 and port 5. The total momentum of the combustion oxidant and fuel fired in port 6 was 5.58 kg m/s².

FIG. 5 is a graphical representation of the oxygen concentration profile of the furnace atmosphere (in vol. % wet) near the glassmelt surface in the furnace of FIG. 1 when operated with the embodiment of the present invention shown in FIG. 3. An opposing pair of oxy-fuel burners of the type described in U.S. Pat. No. 5,601,425 were placed as injectors 32 and 33 in side walls 22 at 2.475 m from the axis of port 6 (by which is meant the axis of ports 6L and 6R) to the axis of the injector in the refining zone. The firing rate of port 6 was reduced, which reduced the total momentum of port 6 to 3.4 kg m/s². The total momentum of the combustion oxidant and fuel oil and atomizing air fired from each of injectors 32 and 33 was 8.3 kg m/s². The combustion stoichiometric ratio of fuel oil to oxidant plus atomizing air was set to produce combustion products with 2% excess O₂ by volume on a wet basis. The momentum ratio of (port 6+injector 32)/(injector 33) was 1.4 in this example.

The computational fluid dynamics model of the glass furnace found that the lowest local O₂ concentration was about 10 vol. % near a corner formed by side wall 22 and front wall 23 of the refilling zone. Except for small areas near the port 28 in wall 23, the oxygen concentration in most of the refining zone is between 10 vol. % and 16 vol. %, The average oxygen concentration in the refining zone was estimated to be about 14%, a surprising large increase compared to the average concentration of about 5% estimated for the condition depicted in FIG. 1 when operated without the present invention. Since the combustion stoichiometric ratio of the oxy-fuel burners was set to produce excess O₂ in the combustion product of 2% on a wet basis, simple mixing of the combustion products from oxy-fuel burners would have reduced the average oxygen concentration in the refining zone. Without being bound by any particular theory, these observations are consistent with the proposition that the jet momentum of two opposing jets or flames from injectors 32 and 33 was sufficiently large relative to that of the flame from ports 6L and 6R and, hence, reduced the normal circulation pattern of the gaseous combustion products from melting zone 11 into refining zone 12, and increased the average oxygen concentration of the atmosphere in the refining zone.

The location and momentum of each gas stream from injectors 32 and 33 are selected such that the circulation of the gaseous combustion products from melting zone 11 into refining zone 12 is lessened and preferably minimized. Preferably the ratio of the sum of the total momentum of port 6 and the total momentum of injector 32 to the total momentum of injector 33 is between 0.25 and 3.0, more preferably between 0.5 and 2.0.

Since said gaseous combustion products contain a significant concentration of alkali vapors (mostly NaOH and KOH), reduction of the circulation of these products from the melting zone 11 into the refining zone 12 reduces the concentration of the alkali vapor in the refining zone 12 as long as the conditions of the refining zone is set to minimize the volatilization of alkali vapors. In this way the invention helps to reduce glass defects caused by alkali corrosion of silica-based materials of construction of the crown. It also improves the oxidation state of the glass by a higher average oxygen concentration in the refining zone and reduces glass color defects caused by a low O₂ concentration in the refining zone. Since glass becomes more oxidized and the redox ratio is reduced with the present invention, the invention is advantageous for the production of highly oxidized glass such as flat glass useful e.g. for solar panel applications and for glass tablewares.

The present invention lessens or minimizes the mixing of the furnace gases from melting zone 11 into the refining zone 12 and increases the purging effect of the gas stream 50 (e.g. air) (when present, i.e. from conditioning zone 13) and optional purge gas streams 55-58 into refining zone 12.

Instead of using two continuously flowing injectors 32 and 33 such as an opposing pair of oxy-fuel burners, the flows from injectors 32 and 33 can be alternated so that gas flows from only one of them at a time, with flow from the single jet that is on the side of the furnace opposite to the side from which a flame is issuing from a port 6. The momentum of the single jet is preferably within 25 to 300%, more preferably within 50 to 200% of the momentum of the flame from port 6. The angle of the single jet is preferably set toward the firing side of port 6 or parallel to the front wall 23.

A preferred embodiment of the invention, whether injectors 32 and 33 are injecting together or alternating, is to inject air or oxidant containing 21 to 100% O₂ by volume. More preferably the oxygen concentration of the oxidant is 33 to 100 vol. % and most preferably the oxygen concentration of the oxidant is 85 to 100 vol. %. The gas compositions injected from injectors 32 and 33 and/or the stoichiometric ratios of the flames injected from injectors 32 and 33 can be different from each other, to affect the temperature and the O₂ concentration profiles in refining zone 12. By injecting oxidant containing O₂ at a concentration higher than the average O₂ concentration in the refining zone, without injecting fuel which consumes oxygen by combustion reactions, the oxygen concentration in the refining zone is increased significantly by the present invention. For example, typical average oxygen concentration of oxygen in the refining zone of a glass furnace making flat glass is in a range of 1% to 6% O₂ by volume on a wet basis. A preferred embodiment of the invention, whether injectors 32 and 33 are injecting together or alternating, is to inject oxidant to increase the average concentration of oxygen in the refining zone by 1 to 60% O₂ by volume to create an atmosphere containing 2% to 60% O₂ by volume on a wet basis. More preferably air or oxidant containing 21 to 100% O₂ by volume, optionally preheated, is injected to increase the average concentration of oxygen in the refining zone by 1 to 40% O₂ by volume to create an atmosphere containing 2% to 40% O₂ by volume on a wet basis. Most preferably air or oxidant containing 21 to 100% O₂ by volume, optionally preheated, is injected to increase the average concentration of oxygen in the refining zone by 2 to 20% O₂ by volume to create an atmosphere containing 3% to 20% O₂ by volume on a wet basis. Average concentration of oxygen in any given region, such as near the bath surface, is determined by measuring the oxygen concentration values at two or more locations in the given region and averaging the measured values.

The atmospheric conditions in refining zone 12 can be further enhanced by optionally injecting an additional purge gas into refining zone 12 in such a way not to increase the furnace gas circulation from melting zone 11 to refining zone 12. For example, additional oxygen can be injected from one or more purge gas injectors 55-58 located in front wall 23 or in side walls 22 near front wall 23. A preferred embodiment is to inject purge gas from injectors 55 and 56 from front wall 23 at proper momentums so as to reduce the furnace gas circulation from melting zone 11, whether purge gas injectors 55 and 56 are injecting together or alternating. Preferably the total momentum of purge gas injected from each injector 55 and 56 is less than that of fuel and air injected from port 6. The purge gas is preferably air or oxidant containing 21 to 100% O₂ by volume. More preferably the oxygen concentration of the oxidant is 33 to 100 vol. % and most preferably the oxygen concentration of the oxidant is 85 to 100 vol. %. The gas flow rates and compositions injected from purge gas injectors 55 and 56 can be different from each other, to affect the temperature and the O₂ concentration profiles in refining zone 12.

When practicing the present invention with the optional purge gas or with oxidant injection from injectors 32 and 33, the average excess oxygen in flue gas exiting the regenerator ports would increase. Injection of oxidant without preheating, especially air, increases the furnace heat load. In order to maintain or improve the energy efficiency of the furnace and to minimize the emission of NOx the fuel and combustion air flow rates of each regenerator port are preferably adjusted to make the oxygen concentration in the flue gas exiting each regenerator port at an optimum value, typically about 1 to 6 vol. %, more typically about 1 to 3 vol. %. Since most of the gases injected into the refining zone exit from the regenerator ports close to the refining zone, the fuel and combustion air flow rates of two to three regenerator ports are preferably adjusted to make the oxygen concentration in the flue gas exiting each regenerator port at an optimum value.

What is claimed is:

1. A method of operating a glassmelting furnace, the furnace including a glassmelting chamber defined by opposed side walls, a back wall, a roof, and a front wall, the method comprising:
(A) melting glassmaking material in a melting zone of said glassmelting chamber to establish a bath of molten glassmaking material, by heat provided to the melting zone over said bath by combustion of fuel and preheated oxidant from two or more pairs of opposed regenerator ports in said side walls of said glassmelting furnace, wherein said combustion forms an atmosphere comprising combustion products over said bath in said melting zone,
(B) passing molten glassmaking material from the melting zone into and through a refining zone of the glassmelting chamber, and then out of said giassmelting chamber through a port in said front wall, without combustion of fuel and oxidant in said refining zone over said molten glassmaking materials, and
(C) injecting at least one gaseous stream or atomized fluid stream into the refining zone above the molten glassmaking material, from at least one location in at least one side wall of said refining zone, in a direction toward the other side wall of said refining zone, or from at least one location in said front wall in a direction toward said back wall, with sufficient momentum to reduce the flow of said combustion products from said melting zone into said refining zone.

2. A method according to claim 1 further comprising (D) flowing a gas stream through said port or through at least one separate gas injection port in the front wall into said refining zone toward said melting zone above the molten glassmaking material.

3. A method according to claim 2 wherein molten glassmaking material flows out of said refining zone into a conditioning zone, and cooling air is fed into said conditioning zone to cool said molten glassmaking material in said conditioning zone, and a portion of said cooling air flows from said conditioning zone into said refining zone and comprises said gas stream that flows into said refining zone.

4. A method according to claim 1 wherein the oxygen concentration in the atmosphere near said bath surface in said refining zone is higher than the oxygen concentration in the atmosphere near said bath surface in said melting zone.

5. A method according to claim 1 wherein said gaseous stream or said atomized fluid stream that is injected in accordance with step (C) is formed by oxy-fuel combustion.

6. A method according to claim 1 wherein said gaseous stream that is injected in accordance with step (C) is air.

7. A method according to claim 1 wherein said gaseous stream that is injected in accordance with step (C) has an oxygen content higher than 21 vol. %.

8. A method according to claim 1 wherein the average oxygen concentration in the atmosphere near said bath surface in said refining zone is between 2 and 60 vol. %.

9. A method according to claim 1 wherein the average oxygen concentration in the atmosphere near said bath surface in said refining zone is increased by 1 to 60 vol. %.

10. A method according to claim 1 wherein the redox ratio, expressed as the ratio of ferrous iron to ferric iron in glass produced from said glassmelting furnace is reduced by 0.01 to 0.20.

11. A method according to claim 1 wherein the fuel and combustion air flow rates of each regenerator port are adjusted to make the oxygen concentration in the flue gas exiting each regenerator port between 1 to 6 vol. %,

12. A method according to claim 1 wherein preheated oxidant for combustion is provided to the melting zone over said bath from two to ten pairs of regenerator ports in the sides of the glassmelting chamber.

13. A method according to claim 2 wherein said gas stream that flows into said refining zone in accordance with step (D) is air.

14. A method according to claim 2 wherein said gas stream that flows into said refining zone in accordance with step (D) comprises 21 vol. % to 100 vol. % oxygen.

15. A method according to claim 2 wherein said gas stream that flows into said refining zone in accordance with step (D) comprises 50 vol. % up to 100 vol. % oxygen.

16. A method according to claim 1 wherein said glassmelting furnace produces oxidized flat glass.

17. 13. A method according to claim 1 wherein said gaseous or atomized fluid stream that is injected from said side wall in accordance with step (C) has a momentum that is greater than at least 25% of the total momentum of the fuel and the oxidant injected from the regenerator port located closest to said refining zone.

18. A method according to claim 1 wherein said gaseous or atomized fluid stream that is injected from said side wall in accordance with step (C) has a momentum that is greater than the total momentum of the fuel and the oxidant injected from the regenerator port located closest to said refining zone.

19. A method according to claim 1 wherein said gaseous or atomized fluid stream that is injected from said front wall in accordance with step (C) has a momentum that is less than the total momentum of the fuel and the oxidant injected from the regenerator port located closest to said refining zone.

20. A method according to claim 1 wherein said injection of at least one gaseous stream into the refining zone above the molten glassmaking material reduces the flow of said combustion products from said glassmelting zone into said refining zone by at least 10%.

21. A method according to claim 1 wherein said injection of at least one gaseous stream into the refining zone above the molten glassmaking material reduces the flow of said combustion products from said glassmelting zone into said refining zone by at least 20%.

22. A method according to claim 1 wherein said injection of at least one gaseous stream into the refining zone above the molten glassmaking material reduces the flow of said combustion products from said glassmelting zone into said refining zone by at least 50%.

23. A method of operating a glassmelting furnace, the furnace including a glassmelting chamber defined by opposed side walls, a back wall, a roof, and a front wall, the method comprising:
(A) melting glassmaking material in a melting zone of said glassmelting chamber to establish a bath of molten glassmaking material, by heat provided to the melting zone over said bath by combustion of fuel and preheated oxidant from two or more pairs of opposed regenerator ports in said side walls of said glassmelting furnace, wherein said combustion forms an atmosphere comprising combustion products over said bath in said melting zone,
(B) passing molten glassmaking material from the melting zone into and through a refining zone of the glassmelting chamber, and then out of said glassmelting chamber through a port in said front wall, without combustion of fuel and oxidant in said refining zone over said molten glassmaking materials,
(C) injecting at least one gaseous stream or atomized fluid stream comprising 21 vol. % to 100 vol. % oxygen into the refining zone above the molten glassmaking material to increase the average oxygen concentration in the atmosphere near said bath surface in said refining zone by 1 to 60 vol. %, and
(D) adjusting the fuel and combustion air flow rates of each of said regenerator ports to make the oxygen concentration in the flue gas exiting each of said regenerator ports between 1 to 6 vol. %,

24. A method according to claim 23 wherein the average oxygen concentration in the atmosphere near said bath surface in said refining zone is increased to 5 to 60 vol. %.

25. A method according to claim 23 wherein said at least one gaseous stream or atomized fluid stream is preheated.
